(19) United States
(12) Patent Application Publication
(10) Pub. No.: US 2019/0262862 A1
(43) Pub. Date: Aug. 29, 2019

(54) Method for Applying a Coating in a Tubular

(71) Applicant: T.F. Warren Group Corporation, The Woodlands, TX (US)

(72) Inventors: Jeffrey Lloyd Hill, Stagecoach, TX (US); Jay Howard Soper, Huffman, TX (US); Christopher Andrew Blinn, Anderson, TX (US)

(73) Assignee: T.F. Warren Group Corporation, The Woodlands, TX (US)

(21) Appl. No.: 16/285,025

(22) Filed: Feb. 25, 2019

Related U.S. Application Data
(60) Provisional application No. 62/634,637, filed on Feb. 23, 2018.

(51) Int. Cl. B05D 7/22; F16L 58/10; B05D 5/08; F16L 55/26

(52) U.S. Cl. CPC B05D 7/225; F16L 58/1027; F16L 2101/16; F16L 55/26; B05D 5/08

(57) ABSTRACT

A method for applying a coating to a tubular may comprise identifying a tubular, inserting a robot into the tubular, activating the robot to move through the tubular, applying a coating to the tubular with the robot, and removing the robot from the tubular.

### BACKGROUND

Water systems are utilized everywhere for transporting and processing water. With the ever-increasing population, the existing underground water systems must be expanded in order to adequately support more people. Additionally, proper maintenance must be administered to sustain an adequate supply of water that is not contaminated. Problems arise when additions or repairs to the network of water systems occur. Construction spanning over a large area affects people for a long period of time. Currently, replacing and/or renovating underground water systems generally involves excavation, removal, and complete replacement. This may be time consuming, expensive, and may disturbing traffic patterns and local residents. A full replacement processes may be lengthy and expensive. Therefore, there is a need for systems and methods that perform maintenance on underground water systems that do not have large impacts on the environment and people.

### BRIEF DESCRIPTION OF THE DRAWINGS

These drawings illustrate certain aspects of some examples of the present disclosure, and should not be used to limit or define the disclosure.

FIG. 1A illustrates an embodiment of a water system.

FIG. 1B illustrates another embodiment of the water system.

FIG. 2 illustrates a flow chart for rehabilitating a tubular.

FIG. 3 illustrates an embodiment of a robot.

### DETAILED DESCRIPTION

This disclosure may generally relate to methods for applying coatings within tubulars. Methods of the present disclosure may be employed to reduce a number of structural problems experienced by tubulars over time.

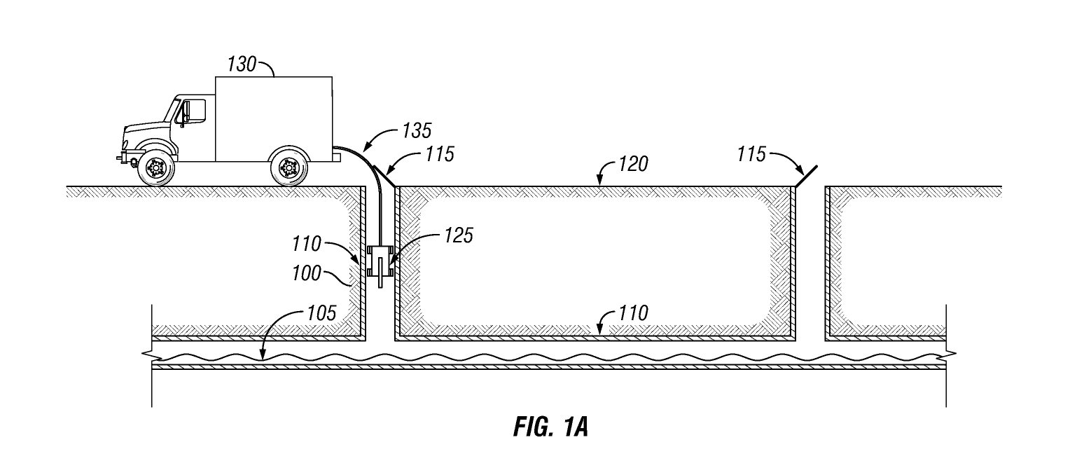

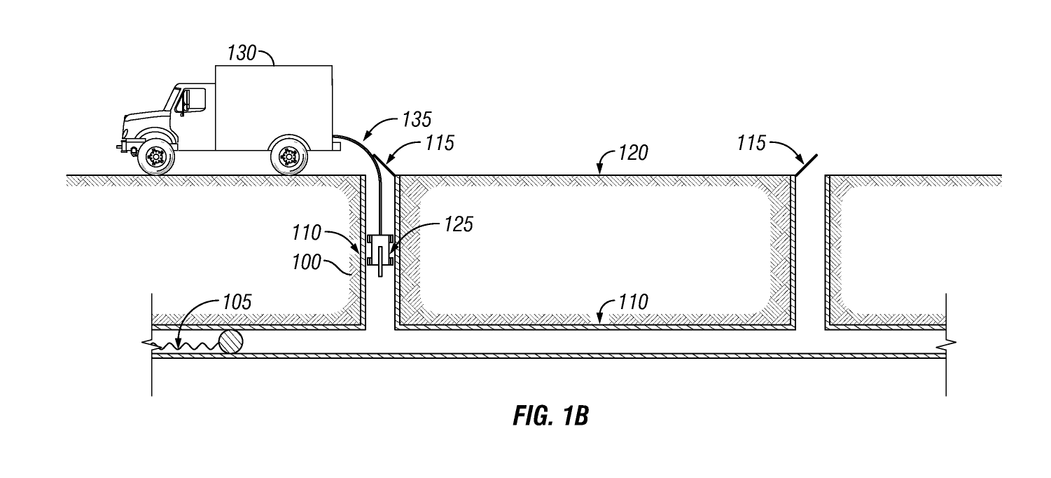

FIG. 1A and FIG. 1B illustrate an embodiment of a water system 100. Water system 100 may serve to transport water 105 across certain distances. Water system 100 may comprise a tubular 110, water 105, and an opening 115. Water system 100 may comprise of a plurality of tubulars 110 and at least one openings 115. As illustrated, water 105 may be disposed within tubulars 110.

Tubulars 110 may connect to additional tubulars 110 to form a network in which water 105 may traverse through. Without limitations, tubulars 110 may be disposed below and or above surface 120. Tubulars 110 may be oriented horizontally, vertically, or at any suitable angle. Tubulars 110 may have any suitable cross-sectional shape. Without limitation, a suitable shape may be circular, elliptical, triangular, rectangular, square, hexagonal and/or any combination thereof. In embodiments, tubulars 110 are cylindrical. Tubulars 110 may be made from any suitable material. Without limitation, suitable material may be cement, metals, nonmetals, polymers, rubbers, composites and/or any combination thereof. In embodiments, tubulars 110 may comprise of concrete. Any variety of cement may be suitable for the use of forming concrete including those comprising calcium, aluminum, silicon, oxygen, iron, sulfur and/or combinations thereof which set and harden by reacting with water. Without limitation, Portland cements, pozzolan cements, gypsum cements, high alumina content cements, silica cements, slag cements and/or any combinations thereof may be used. An end of tubular 110 may lead to opening 115.

Opening 115 may be an entry point into water system 100. Opening 115 may allow a person to enter into the network created by a plurality of tubulars 110. In embodiments, opening 115 may allow a robot 125 to enter into the network created by a plurality of tubulars 110. In embodiments, opening 115 may be a manhole. Opening 115 may be covered to prevent accidental or unauthorized access to water system 100. The covering placed over opening 115 may be made of any suitable material. Without limitation, suitable material may be metals, nonmetals, polymers, rubbers, composites and/or any combination thereof. In embodiments, the covering may be made of metal, precast concrete, glass reinforced plastic and/or combinations thereof.

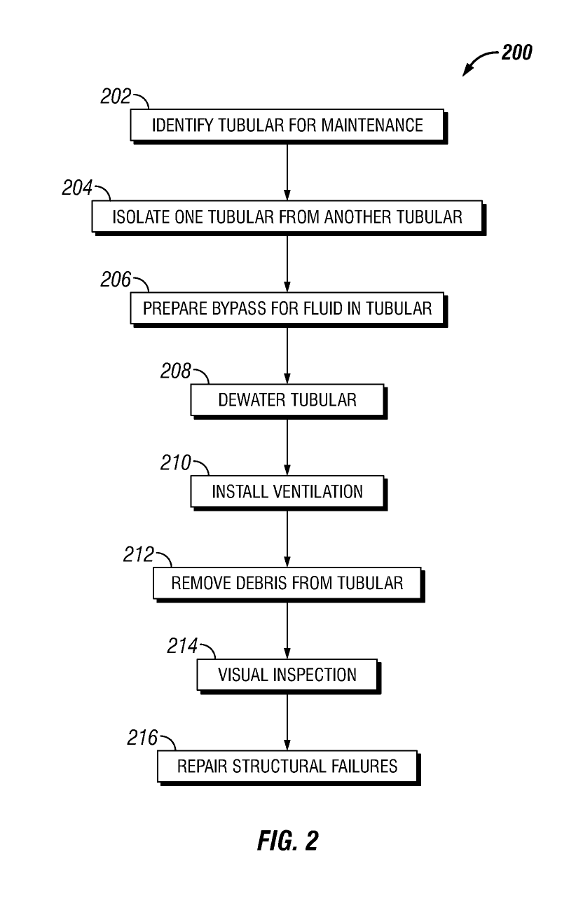

As discussed above, as tubulars 110 age over time, tubulars 110 may begin to crack, break, corrode, fall apart, and/or the like. It may be cost prohibitive to dig up tubulars 110 and replace them. Systems and methods may be implemented to fix, clean, and coat tubulars 110, which may extend the useable life of tubulars 110 without replacing aged tubulars 110. FIG. 2 illustrates a flow chart 200 for preparing a tubular 110 or a plurality of tubulars 110 to be rehabilitated to increase the useful life of tubulars 110. In block 202 of flowchart 200 a tubular 110 or a plurality of tubulars 110 may be identified for maintenance. Identifying tubulars 110 in need of maintenance may come from surveys, on site inspections by personnel or autonomous devices, scheduled maintenance, and/or the like. Identified tubulars 110 may be isolated for further inspection and/or future maintenance.

In block 204, identified tubulars 110 may be isolated from other tubulars 110 and elements, which may allow selected tubulars 110 to be treated. For example, inflatable plugs may be deployed within tubulars 110. Without limitation, the inflatable plugs may be of various sizes and may be inflated to prevent elements, such as water and/or sewage from traversing from one tubular 110 to an identified tubular 110 that may need treatment and/or maintenance. Deploying an inflatable plug may act as a dam and/or blockage that may allow for water and/or sewage to pool behind the inflatable plug. This may add additional pressure to the inflatable plug, which may cause the inflatable plug to fail. To prevent failure of the inflatable plug, elements, such as water and/or sewage may be removed.

In block 206, water and sewage may bypass and/or be diverted around the inflatable plug to a designated area away from identified tubulars 110 that may be under maintenance and/or treatment. Without limitation, water and/or sewage may be pumped away from the inflatable plugs and through hoses to the designated area. In examples, pumps may be self-priming and the size of pumps may be determined based at least in part on predicted gallons per minute of water and/or sewage that may flow through tubulars 110 during heavy rain storms. Additionally, it should be noted that secondary bypass lines may be utilized to divert water and/or sewage that may flow into identified tubulars 110 past the inflatable plugs through lateral lines that may drain into isolated areas. Bypassing water and sewage around identified tubulars 110 in block 206 may allow for dewatering of the identified tubulars 110.

Dewater of identified tubulars 110 in block 208 may include removing standing water from identified tubular 110. Additionally, as discussed above, identified tubulars 110 may have cracks and/or breaks within tubular 110. This may allow ground water to seep into identified tubulars 110. To prevent ground water from seeping into identified tubulars 110 a well point may be drilled in the earth around identified tubular 110. The well point may pull ground water away from the identified tubulars 110, which may prevent ground water from seeping into identified tubulars 110 through cracks, joints, voids, and/or the like. Ground water collected at the well points may be pumped out and away from the area. Other water diversion methods may also be utilized to facilitate in the removal of ground water. Tubulars 110 may also dry with proper ventilation.

In block 210, ventilation may be installed on the surface and/or in tubulars 110 to drive fresh, breathable, air into tubulars 110, which may allow for personnel to enter tubulars 110. Ventilation may be provided by any suitable fan, which may push and/or pull air through the identified tubulars 110. During maintenance operations, the fans may be utilized to direct airflow and control overspray during spraying operations. It should be noted that a plurality of fans may work together and in tandem to help draw air through the area. Without limitation, fans may be placed in the manholes, surface, and tubulars 110 to provide a safe working environment that may also help in the removal of residual water within identified tubulars 110. The establishment of a work environment and removal of water within the identified tubulars 110 may allow for treatment and operations to begin.

In block 212, treatment and/or maintenance operations may begin with the removal of any debris that may be left from dewatering in block 208. This may include removing sand and/or heavy material that may have settled in identified tubular 110. A cleaning operation may also be undertaken to remove the grime and debris that may be stuck to identified tubulars 110.

After the remove of debris in block 212, a visual inspection in block 214 may be performed to inspect joints, cracks, voids, holes, and/or the like to determine areas that may need to be filled and/or refurbished. Identified areas may be marked and/or tagged by any suitable means. In block 216 the identified areas may be repaired. Repairs may be performed utilizing resin injections. Resin injection operations may be performed by drilling and installing injection ports around identified area. A hydrophobic resin may be injected into the drilled ports. This operation may be performed injection hydrophobic resin at the lowest point of an identified area and working upwards. The hydrophobic resin may activate and expand upon reacting with water, such as ground water that may not have be pulled away with the well points discussed above. Larger identified areas may be filled in and repaired using a hydraulic concrete mortar mix, which may be used in conjunction with the hydrophobic resin. During operations, unidentified joints cracks, voids, holes, and/or the like may appear as ground water moves from a repaired area to the unidentified joints cracks, voids, holes, and/or the like. During operation in block 216, personnel may move through and repair different areas of the identified tubulars 110 any number of times.

After preparation workflow 200 has been completed. A coating operation may be initiated with a robot 125, referring back to FIG. 1A and FIG. 1B. In FIGS. 1A and 1B, robot 125 may be lowered into tubular 110 through opening 115. Robot 125 may be tethered to a vehicle 130. Vehicle 130 may be any suitable vehicle capable of supporting robot 125 and ancillary equipment. Ancillary equipment may include chemical storage tanks, generators, pumps, etc. Robot 125 may be tethered to a vehicle 130 through a conveyance 135.

Conveyance 135 may lower robot 125 below surface 120 through opening 115. In embodiments, robot 125 may be attached to a first end of conveyance 135 and vehicle 130 may be attached to a second end of conveyance 135. Conveyance 135 may include any suitable means for providing mechanical conveyance for robot 125, including, but not limited to, wires, cables, tubing, pipes or the like. In some embodiments, conveyance 135 may provide mechanical suspension, as well as electrical connectivity, for robot 125. Conveyance 135 may comprise, in some instances, a plurality of electrical conductors extending from vehicle 130. Conveyance 135 may comprise an inner core of electrical conductors covered by an insulating wrap. An inner and outer steel armor sheath may be wrapped in a helix in opposite directions around the conductors. The electrical conductors may be used for communicating power between vehicle 130 and robot 125. Conveyance 135 may allow for information to be transferred between robot 125 and vehicle 130.

Information from robot 125 may be processed by an analysis unit. The processing may be performed real-time or after recovery of robot 125. Processing may alternatively occur underground or may occur both underground and at surface 120. In some embodiments, signals recorded by robot 125 may be conducted to an analysis unit by way of conveyance 135.

An analysis unit may process the signals, and the information contained therein may be displayed for an operator to observe and stored for future processing and reference. In examples, an operator may be defined as an individual, group of individuals, or an organization. An analysis unit may also contain an apparatus for supplying control signals and power to robot 125. An analysis unit may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an analysis unit may be a processing unit, a network storage device, or any other suitable device and may vary in size, shape, performance, functionality, and price. An analysis unit may include random access memory (RAM), one or more processing resources such as a central processing unit (CPU) or hardware or software control logic, ROM, and/or other types of nonvolatile memory. Additional components of an analysis unit may include one or more disk drives, one or more network ports for communication with external devices as well as an input device (e.g., keyboard, mouse, etc.) and video display. An analysis unit may also include one or more buses operable to transmit communications between the various hardware components.

Alternatively, systems and methods of the present disclosure may be implemented, at least in part, with non-transitory computer-readable media. Non-transitory computer-readable media may include any instrumentality or aggregation of instrumentalities that may retain data and/or instructions for a period of time. Non-transitory computer-readable media may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

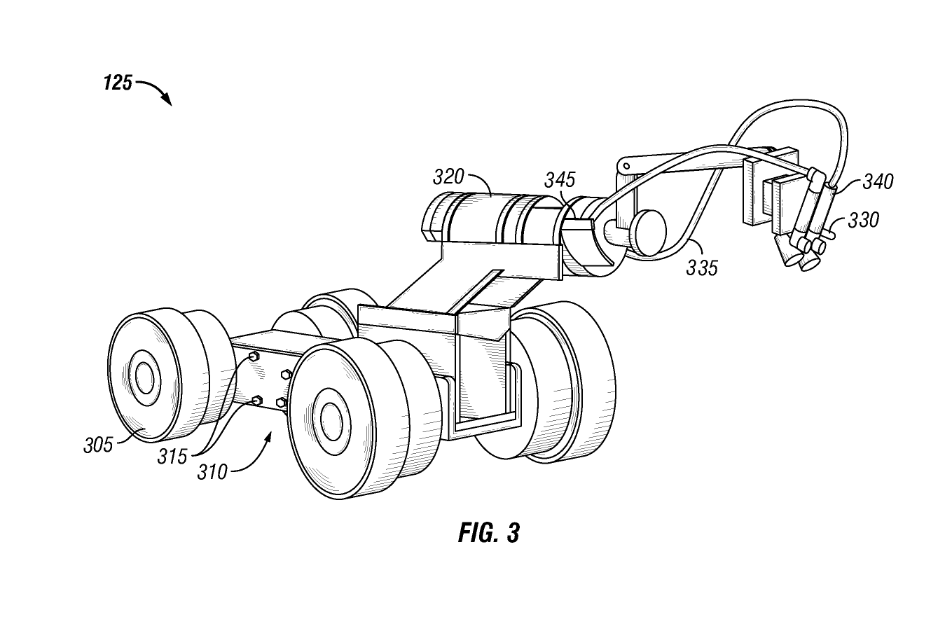

An embodiment of robot 125 is illustrated in FIG. 3. Robot 125 may function and/or operate to maintain, seal, and/or inspect tubulars 110 (e.g., Referring to FIGS. 1A and 1B). For example, robot 125 may maintain tubulars 110 by applying any number of coating to an inner surface of tubulars 110. To perform such operations, robot 125 may comprise a wheel 305, a chassis 310, a motor 320, a power source, a nozzle 330, and a hose 335. In embodiments, there may be a plurality of wheels 305. For example, robot 125 may comprise of four wheels 305. Generally, wheel 305 may be any suitable size and shape that may be capable of allowing robot 125 to move from one position to a second position. Without limitation, wheel 305 may be able to turn on an axle and may have the capacity to structurally support robot 125. It should be noted that tracks may be used in placed of wheels 305. As illustrated in FIG. 2, wheel 305 may be disposed on the bottom of chassis 310.

Chassis 310 may provide a base, structural framework, for robot 125. Different parts and components may be disposed upon and/or within chassis 310. Chassis 310 may comprise multiple individual members that form a frame to support a structure. These members may be connected through the use of suitable fasteners. Without limitation, suitable fasteners may be nuts and bolts, washers, screws, pins, sockets, rods and studs, hinges and/or any combination thereof. Chassis 310 may be made of any suitable material. Without limitation, suitable material may be metals, nonmetals, polymers, rubbers, composites and/or any combination thereof. Chassis 310 may be any suitable shape. Without limitation, a suitable shape may be circular, elliptical, triangular, rectangular, square, hexagonal and/or any combination thereof. In embodiments, chassis 310 may have a rectangular shape. Chassis 310 may have connection points 315 to allow for different parts and components to be fastened on, through, and/or within chassis 210. In embodiments, there may be two parallel connection points 315 running perpendicularly through a set of parallel sides. These connection points 315 may be used to attach a plurality of wheels 305 to chassis 310 through the use of any suitable parts. Without limitation, suitable parts may include an axle, an axle nut, and a seal. In embodiments, chassis 310 may be constructed to support motor 320.

Motor 320 may be any machine that converts electrical energy into mechanical energy to produce a rotary force. Motor 320 may be any suitable size and shape to be supported by chassis 310. As illustrated in FIG. 3, motor 320 may be disposed onto chassis 310. In embodiments, motor 320 may be disposed anywhere on chassis 310 that does not interfere with the movement of wheels 305. Without limitation, motor 320 may be a brushed DC motor, an electronic commutator motor, a universal AC-DC motor, an induction motor, a synchronous motor, a magnetic rotary motor and/or combinations thereof. Motor 320 may require a power source in order to operate.

The power source may be a source of electrical energy that may be supplied to motor 320 for operation. The power source may be coupled to motor 320 through electrically conductive wires. The power source may be disposed on chassis 310 and/or at a location apart from serer robot 125. Without limitation, the power source may be an electrical generator and/or a battery. The power source may supply motor 320 with enough energy to move a plurality of wheels 305 and nozzle 330.

Nozzle 330 may be used to control outward fluid flow from an enclosed space. There may be a plurality of nozzles 330. Nozzle 330 may be made of any suitable material. Without limitation, suitable material may be metals, nonmetals, polymers, rubbers, composites and/or any combination thereof. Nozzle 330 may be any suitable shape wherein the cross-sectional area of the shape varies with length. In embodiments, nozzle 330 may be conical. Nozzle 330 may be hollow. Nozzle 330 may have one end that has a larger cross-sectional area than the other end. Without limitation, nozzle 330 may be a jet nozzle, convergent nozzle, divergent nozzle, de Laval nozzle, propelling nozzle, magnetic nozzle, a spray nozzle and/or any combinations thereof. In embodiments, nozzle 330 may be a spray nozzle used for spraying coatings. Nozzle 330 may be indirectly coupled to motor 320 through hose 335. In embodiment, nozzle 330 may rotate 360 degrees, which may allow nozzle 330 to spray a coating to any surface within tubular 110.

Hose 335 may be a hollow tubular comprising a first end 340 and a second end 345. Hose 335 may serve to transport chemical compositions to nozzle 330. Hose 335 may have nozzle 330 disposed at first end 340, and a chemical housing unit (not illustrated) may be disposed at second end 345. In examples, a chemical composition disposed in the chemical housing unit may be transported through hose 335 to nozzle 330. Without limitation, motor 320 may act as a pump to pull the chemical composition from the chemical housing unit to nozzle 330. Hose 335 may be made of any suitable material. Without limitation, suitable material may be metals, nonmetals, polymers, rubbers, composites and/or any combination thereof. Hose 335 may be any suitable shape. Without limitation, a suitable shape may be circular, elliptical, triangular, rectangular, square, hexagonal and/or any combination thereof.

Referring back to FIG. 1A and FIG. 1B, robot 125 may be lowered through opening 115 by conveyance 135. Prior to conveyance 135 lowering robot 125 through opening 115, water 105 may be removed from tubular 110. An operator may provide a means to block off at least a portion of tubular 110 so as to prevent water 105 from entering and remaining within tubular 110. This may be done through an automatic and/or manual process. Once conditions inside tubular 110 may be acceptable, robot 125 may be lowered through opening 115 via conveyance 135. In embodiments, opening 115 is disposed at a first end of a first tubular 110A that is oriented vertically below the ground. A second tubular 110B is disposed perpendicularly at a second end of first tubular 110A. Robot 125 may spray a first coating as it is being lowered through first tubular 110A. Robot 125 may spray a first coating as it moves forward. Robot 125 may spray a second coating as it moves backward after reaching the end of second tubular 110B. Robot 125 may be able to spray a coating by rotating nozzle 230 three hundred and sixty degrees. Conveyance 135 may begin to lift robot 125 from second tubular 110B and transport it through first tubular 110A to reach opening 115. As robot 125 travels through first tubular 110A, it may spray a second coating. Although individual examples are discussed, the disclosure covers all combinations of all examples (i.e. multiple vertical and horizontal tubulars). An operator may provide a means to allow water 105 to pass through the newly coated tubulars 110 once the coatings dry.

The foregoing figures and discussion are not intended to include all features of the present techniques to accommodate a buyer or seller, or to describe the system, nor is such figures and discussion limiting but exemplary and in the spirit of the present techniques.

What is claimed is:

1. A method for applying a coating to a tubular, comprising:
identifying a tubular
inserting a robot into the tubular;
activating the robot to move through the tubular;
applying a coating to the tubular with the robot; and
removing the robot from the tubular.

2. The method of claim 1, further comprising applying a second coating to the tubular with the robot.

3. The method of claim 1, wherein the robot comprises:
a chassis which may be configured to structurally support the robot;
one or more wheels attached to the chassis;
at least one power source attached to the chassis and configured to power the robot; and
a nozzle attached to the chassis and configured to spray the coating to the tubular.

4. The method of claim 3, wherein the nozzle rotates 360 degrees.

5. The method of claim 3, further comprising a hose attached to the nozzle and a chemical housing unit and configured to transport a chemical composition from the chemical housing unit to the nozzle.

6. The method of claim 1, further comprising preparing a bypass for a fluid that moves through the tubular and dewatering the tubular.

7. The method of claim 6, further comprising inflating an inflatable plug within the tubular to prevent the fluid from moving through the tubular.

8. The method of claim 6, installing one or more pumps to dewater the tubular.

9. The method of claim 1, installing one or more well points around the tubular to remove ground water from the tubular.

10. The method of claim 1, repairing the one or more structural failures in the tubular with at least a hydrophobic resin.

11. A method for applying a coating to a tubular, comprising:
identifying a tubular from a plurality of tubulars for maintenance;
isolating the tubular form the plurality of tubulars;
preparing a bypass for a fluid that moves through the tubular;
dewatering the tubular;
installing ventilation within the tubular;
removing debris from the tubular;
inspecting the tubular for one or more structural failures in the tubular;
repairing the one or more structural failures in the tubular;
inserting a robot into the tubular;
activating the robot to move through the tubular;
spraying a coating from the robot on to the tubular; and
removing the robot from the tubular.

12. The method of claim 11, further comprising applying a second coating to the tubular with the robot.

13. The method of claim 11, wherein the robot comprises:
a chassis which may be configured to structurally support the robot;
one or more wheels attached to the chassis;
at least one power source attached to the chassis and configured to power the robot; and
a nozzle attached to the chassis and configured to spray the coating to the tubular.

14. The method of claim 13, wherein the nozzle rotates 360 degrees.

15. The method of claim 13, further comprising a hose attached to the nozzle and a chemical housing unit and configured to transport a chemical composition from the chemical housing unit to the nozzle.

16. The method of claim 11, further comprising applying at least a hydrophobic resin to the one or more structural failures in the tubular.

17. The method of claim 11, further comprising installing one or more well points around the tubular to remove ground water from the tubular.

18. The method of claim 11, further comprising installing one or more pumps to dewater the tubular

19. The method of claim 11, further comprising inflating an inflatable plug within the tubular to prevent the fluid from moving through the tubular.

20. The method of claim 11, further comprising preparing second bypass for the fluid that moves through the tubular.
